(19) United States
(12) Patent Application Publication
(10) Pub. No.: US 2023/0013160 A1
(43) Pub. Date: Jan. 19, 2023

(54) PRIVACY SYSTEM ARRANGEMENT

(71) Applicant: SECURE BROADCAST LTD., Belfast (GB)

(72) Inventors: Helen LENNON, Belfast (GB); Damian PURCELL, Belfast (GB); Kristopher JONES, Belfast (GB); Arun NATARAJAN, Belfast (GB); Frazer ROBINSON, Belfast (GB)

(21) Appl. No.: 17/757,169

(22) PCT Filed: Dec. 9, 2020
(86) PCT No.: PCT/EP2020/085335

§ 371 Date: Jun. 10, 2022

(30) Foreign Application Priority Data
Dec. 11, 2019 (GB) 1918212.0

(51) Int. Cl. H04N 21/84; H04N 21/431; H04N 21/45

(52) U.S. Cl. CPC H04N 21/84; H04N 21/4312; H04N 21/4532

(57) ABSTRACT

A method for distributing video content across a network, the method comprising: providing video data to a primary data source, associating control data with the video data, broadcasting the video data with associated control data from the primary data source to one or more user devices across the network, providing a media player on the respective user devices which is operable in response to reading the control data to create auxiliary data locally on the respective user devices while the media player is playing the video data, creating the auxiliary data locally on the respective user devices while the media player is playing the video data locally on the respective user devices. The control data defines one or more elements of the auxiliary data to be created by the media player including the elements of the auxiliary data which are to be retrieved from the primary data source and one or more secondary data sources.

### FIELD OF THE INVENTION

This invention relates to a method and a system for distributing video content across a network, in particular

### BACKGROUND TO THE INVENTION

Over the past number of years the growth of personalised and contextualised video has grown rapidly. A number of organisations have specialised in personalised video creation and distribution. These organisations include some of the world's largest social media companies. Personalised and contextual videos are created to give users a personalised video experience by including personal information about them in the video.

To keep up with the huge demand for personalised video, companies have created systems that enable a templated video to be combined with data and rendered within their controlled servers, for subsequent distribution to the user. This method of creating personalised video is difficult to scale, very inefficient and cost and time to render increase exponentially as volume increases as each personalised video has to be rendered, stored on the companies' servers prior to distribution. For context, to create 1 video for every user on the worlds largest social media site a company would need to create and store 1.6 billion unique video files. The cost, energy, time and storage size required to meet this demand is incredibly large. Due to this, it makes it very difficult if not impossible for any companies outside of the worlds largest to be able to create personalised videos at any scale. For example as the number of users increases the time, cost, energy required to create personalised videos increases to meet the demand such as can be seen in FIG. 1A for example, generally indicated by the reference numeral 10A. As volume, scale and demand grows for the personalised videos, these problems will increase. Therefore, due to these problems there is an every growing need for the ability to create personalised videos at any scale, quickly and in a much more efficient and energy saving way.

For every video created, all information that is required to be within the video must all be pulled into the video rendering server. This could include secure or personal information. For context, to create a personalised video for all the 1.6 billion users of the largest social media network, 1.6 billion peoples personal data must be retrieved and stored on a video rendering server to enable the creation of the personalised videos. Aside from the technical difficulties associated with this, there are also potentially significant concerns regarding data privacy and security, particularly in light of the recent media, governments focus on data privacy as evidenced by recent data privacy legislation changes such as the General Data Protection Regulations (GDPR) regulations introduced in the European Union in 2018.

Due to such recent privacy laws, it has become increasingly difficult for a first party service wishing to distribute a video that contains personalised information, further to do this with personalised information regarding a user being introduced in real time and at the same time being GPDR compliant is very difficult, if not impossible. This is because in order to achieve this, the first party service will have to retrieve data from one or more different third and/or first party services.

As mentioned above the current practice for creating personalised video at scale typically includes rendering/creating each of the personalised video files in advance of distribution. So, to create 100 personalised videos, 100 video files are created and stored on a server, broadcast to a user device upon which they are stored on the physical memory of the user device. There is a need to provide means by which the amount of time, effort and cost is reduced for distributing personalised video content.

The problems with the current practice are best evidence when considering real world application. For example, take the situation where a company wished to create a location based video that displayed the name of the local pub(s) that served a particular brand of beer during a rugby or football match. For this, they would have to gather all of the third party data containing the location and pub names. From here they would then have to render an individual video personalised for each pub, which can be quite a significant task if the location in particular is a major city such as London, New York or Dublin. Every variation of the base video will require a brand new video to be created that contains the third party data. With currently available technology, all videos must be rendered prior to the user viewing it within a server. This method of video distribution hinders the scalability, time, relevancy of the data. Meaning ultimately the existing method restricts the ability to deliver truly personalised video and/or video with real-time information.

It is a desire of the present invention to overcome the deficiencies highlighted above.

### SUMMARY OF THE INVENTION

Accordingly a first aspect of the invention provides a method for distributing video content across a network, the method comprising: Providing video data to a primary data source; Associating control data with the video data; Broadcasting the video data with associated control data from the primary data source to one or more user devices across the network; Providing a media player on the respective user devices which is operable in response to reading the control data to create auxiliary data locally on the respective user devices while the media player is playing the video data; Creating the auxiliary data locally on the respective user devices while the media player is playing the video data locally on the respective user devices; Wherein the control data defines one or more elements of the auxiliary data to be created by the media player including the elements of the auxiliary data which are to be retrieved from the primary data source and one or more secondary data sources such that there is no data exchange directly between the primary and secondary data sources . Advantageously the present invention therefore provides a method for creating auxiliary data overlaid on top of video data which is created locally on the user device, wherein the auxiliary data created may be based on information retrieved from either of the primary data source and/or secondary data sources with no data exchange occurring directly between the primary data source and secondary data source therefore ensuring that information regarding the user of the user device upon which the video is played back and upon which the auxiliary data is created locally in real time is kept private with the provider of the personal information, either of the primary or secondary data sources, being aware of only the content they provided to the media player.

A second aspect of the invention provides a system for distributing video content across a network, the system comprising: A primary data source; One or more user devices; One or more secondary data sources; Wherein the primary data source is configured to associate control data to video data provided to the primary data source; Wherein the primary data source is configured to broadcast the video data and associated control data for receipt by the one or more user devices; Wherein the user devices contain a media player provided thereon which is configured to create auxiliary data locally upon the respective user device in response to reading the control data when the video is played on the user device; and Wherein the control data defines one or more elements of the auxiliary data created by the media player locally on the user devices including elements of the auxiliary data which are to be retrieved from the primary data source and the one or more secondary data sources.

Preferably, the control data comprises metadata such as for example a data interchange format or data storage format.

Ideally, the control data comprises machine readable mark-up language.

Preferably, the control data contains instructions defining the elements of the auxiliary data, the elements of the auxiliary data comprising one or more of: a layout of the auxiliary data relative to the video data; a type of auxiliary data to be provided relative to the video data; a first location from which the auxiliary data is to be retrieved from the primary data source and/or secondary data sources; a time at which the auxiliary data is to be provided relative to the video data; and/or an action to be performed to the auxiliary data when the video playback is ended.

Ideally, wherein the action to be performed to the auxiliary data when the video playback is ended comprises stopping the rendering of the auxiliary data on the media player.

Preferably, wherein the control data further defines a second location from which the auxiliary data is to be retrieved from the primary data source and/or secondary data sources if the auxiliary data is not available at said first location.

Ideally, wherein the different types of auxiliary data are provided at different times during playback of the video data, typically as dictated by the control data.

Preferably, the different types of auxiliary data comprise: customisable text overlays; or graphics; or sounds; or secondary video data; or special effects or live feeds or displays of information or any combination thereof.

Ideally, the auxiliary data comprises user specific data, wherein the user specific data comprises data regarding a user of the user device.

Preferably, the user specific data comprises one or more of: user location; user age; user gender; user interests or hobbies; user language; user search history; user web history and/or any other suitable user specific information.

Ideally, the user specific data is stored upon one or more of the secondary data sources and/or primary data source and/or user device and/or media player.

Optionally, the secondary data sources from which the media player is configured to retrieve the one or more elements of the auxiliary data to be created by the media player is determined based on one or more elements of the user specific data.

Preferably, prior to creating the auxiliary data locally on the respective user devices while the media player is playing the video data locally on the respective user devices, the method further comprises:

authenticating the media player with the secondary data sources to allow for the media player to retrieve the auxiliary data, preferably the user specific data, from the secondary data sources.

Ideally, authenticating the media player with the secondary data sources comprises requesting the user to provide their consent for the media player to retrieve one or more elements of the auxiliary data from one or more of the secondary data sources.

Preferably, authenticating the media player with the secondary data sources comprises verifying that the user has previously provided their consent for the media player to retrieve one or more elements of the auxiliary data from one or more of the secondary data sources.

Ideally, the control data contains instructions defining what action is to be performed if the user's consent is not obtained or verified.

Preferably, the control data indicates that the video playback on the user device is not to occur on the media player or that pre-defined auxiliary data is to be created during playback of the video on the media player.

Ideally, the type of pre-defined auxiliary data to be created is defined in the control data.

Preferably, the pre-defined auxiliary data is retrieved from the primary data source.

Ideally, the primary data source and/or secondary data sources comprise a cloud and/or local server architecture and/or an API service and/or any data storage format file and/or JSON file and/or a computing device and/or any data storage format or other suitable data source.

Preferably, the media player is configured to create and synchronise the auxiliary data in real time with the video data whilst the video data is played on the user device.

Ideally, the user devices comprises a smartphone, tablet, laptop or any other suitable computing device

### BRIEF DESCRIPTION OF THE DRAWINGS

The invention will now be described, by way of example, with reference to the accompanying drawings:

FIG. 1A is a graph illustrating for the prior art, the time, cost, energy usage as the number of users increases for the generation of personalised videos;

FIG. 1B is a graph illustrating for the present invention, the time, cost, energy usage as the number of users increases for the generation of personalised videos;

FIG. 1 is a schematic diagram showing a system for distributing video content across a network; and

FIG. 2 is a flow diagram showing an authentication process for the system.

### DETAILED DESCRIPTION

The present teaching will now be described with reference to an exemplary video broadcast system. It will be understood that the exemplary broadcast system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

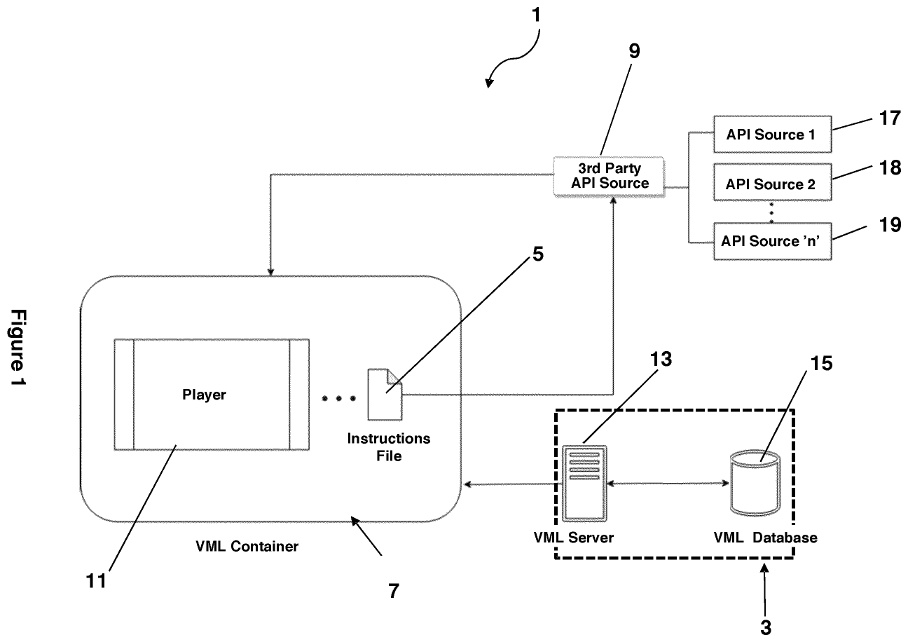

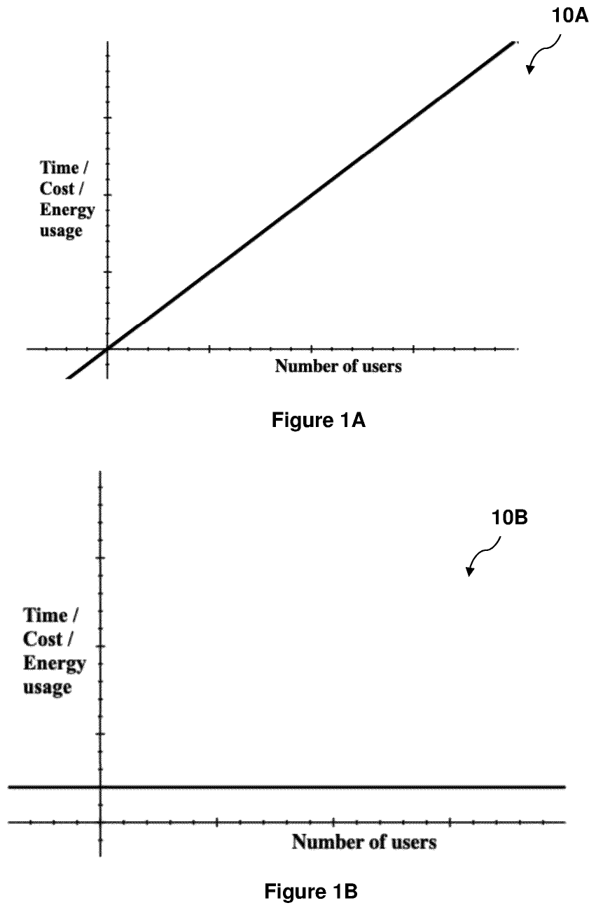

Referring now to the drawings, in particular FIG. 1 thereof, there is shown, generally indicated by the reference numeral 1, a system for distributing video content across a network which embodies an aspect of the present invention. The system comprises a primary data source 3 upon which control data 5 is typically associated with raw video data for broadcast to one or more user devices 7. The raw video data and associated control data are typically broadcast over the network, wherein the network typically comprises the internet. The primary data source 3 may comprise a cloud and/or local server architecture and/or an API service and/or any data storage format file and/or JSON file and/or a computing device and/or any data storage format or other suitable data source. Preferably the primary data source 3 comprises a server 13 having one or more databases 15 provided thereon or which are otherwise accessible thereto. The user devices 7 include a media player 11 provided thereon which is operable in response to reading the control data 5 to create auxiliary data locally on the respective user device 5 whilst playing the video. The control data 5 contains information defining one or elements of the auxiliary data which are to be created or rendered on the user device(s) 7 while the video is being played upon user device 7. The user device 7 comprises a computing device; more preferably the user device comprises a handheld computing device. To this end the user device may comprise a smartphone, tablet, laptop or any other suitable computing device.

The system further comprises one or more secondary data sources 9 from which the user device(s) 7, in particular the media player 11, is operable to communicate with, to retrieve information therefrom. To this end the control data 5 typically defines what information is to be retrieved from both the primary data source 3 and/or the secondary data sources 9. There a number of advantages with the system, the most pertinent of which is that from the user's perspective, i.e. user of the user device 7, there is no data exchange or communication, directly between the primary data source 3 and the secondary data source(s) 9 meaning that the primary data source 3 is unaware of the data provided to the media player 11 of the user device 7 from the secondary data source 9 and in-turn the secondary data source(s) 9 is unaware of the data provided to the media player 11 of the user device 7 from the primary data source 3. This is particularly advantageous from a privacy perspective as the data provided by either of the centres, primary data source 3 and secondary data source 9, may be personal data regarding the users themselves which they wish kept private. The secondary data sources 9 typically comprise cloud and/or local server architectures and/or an API service and/or any data storage format file and/or JSON file and/or a computing device and/or any data storage format or other suitable data source.

A further aspect of the invention provides a method for distributing video content across a network, the method comprising:
Providing video data to a primary data source 3;
Associating control data 5 with the video data;
Broadcasting the video data with associated control data 5 from the primary data source 3 to one or more user devices 7 across the network;
Providing a media player 11 on the respective user devices 7 which is operable in response to reading the control data 5 to create auxiliary data locally on the respective user devices 7 while the media player 11 is playing the video data;
Creating the auxiliary data locally on the respective user devices 7 while the media player is playing the video data locally on the respective user devices 7;
Wherein the control data 5 defines one or more elements of the auxiliary data to be created by the media player 11 including the elements of the auxiliary data which are to be retrieved from the primary data source 3 and one or more secondary data sources 9.

The system 1 as shown in FIG. 1 is configured to implement the method for distributing video content across a network. Further the features of the system 1 further described herein are equally applicable in respect of said method.

The control data 5 is typically associated with the video data at the primary data source 3. In an alternative embodiment the system may further comprise a first device (not shown) which is operable to communicate with the primary data source 3 via wired and/or wireless transmission means. To this end the first device is operable to broadcast data for receipt by the primary data source 3. The control data may be associated with the video data upon the first device, typically by an operator of the first device, wherein the video data and associated control data may subsequently be broadcast simultaneously or separately from the first device to the primary data source 3, typically for onward distribution to the user device 7. Alternatively, in instances where the video data is already provided to the primary data source 3 i.e. where the first device comprises a copy of video data which is already available to the primary data source 3, then only the associated control data may be broadcast to the primary data source 3 for onward distribution. The first device comprises a computing device; more preferably the first device comprises a handheld computing device. To this end the first device may comprise a smartphone, tablet, laptop or any other suitable computing device. The first device may comprise an application or the like which resides thereon which may be employed by a user to add specific auxiliary data to the raw video data.

As mentioned previously the control data 5 contains information defining one or more elements of the auxiliary data which are to be created and applied in real-time to the raw video data during subsequent playback of the video data, typically on the user device 7, via the media player 11 which is installed theron or otherwise accessible thereto. To this end, the control data preferably comprises metadata, for example a data interchange format/or data storage format referred to herein as Video Markup Language (VML)or other machine readable mark-up language. The control data 5 contains instructions defining one or more of: the layout of the auxiliary data relative to the video data; the one or more types of auxiliary data to be provided relative to the video data; the timing at which the auxiliary data is to be provided relative to the video data; and/or the location from which the auxiliary data is to be retrieved such as from the primary data source 3 and/or one or more secondary data sources 9. The auxiliary data may comprise one or more of: customisable text overlays, graphics, sounds, secondary video data, special effects, live feeds or displays of information or any combination thereof. It should be understood that by live feeds it is intended to mean substantially live i.e. in real-time. The created auxiliary data is typically layered on top of or below the video such as to present a synchronous video, however it should be understood that that within the video broadcast system 1 the video remains as raw video independent from the generated auxiliary data, in other words, as a video data without attached graphic(s) or special effects. When the video is viewed by a user using the user device 7 the media player 11 synchronously creates the correct auxiliary data e.g. high quality graphics, text and special effects etc. This auxiliary data is then overlaid by the media player 11, on the respective user devices 11, onto the raw video giving the appearance of a single high quality video file to the end user. In order to layer the created auxiliary data on top of the video data, the video data may be defined as plurality of different display segments, the auxiliary data can be defined as comprising one or a plurality of display segments of the video data. It should be understood that the auxiliary data is only created or rendered on the media player 11 in accordance with the sequence prescribed by the control 5 data only when video playback commences on the media player 11, typically continues to be created only until the point at which the video playback ceases to occur on the media player 11.

The control data 5 typically acts as a placeholder or template defining what type of data is to be inserted or layered on top of the video data as well as when this is to occur, with different elements of auxiliary data being inserted and removed at specific times. It should be understood that all of the auxiliary data is processed and created or rendered locally upon the user devices 7 for insertion relative to the video data by the media player 11. To give an example, the primary data source 3 may be provided with video data comprising an advertisement video for a certain product or service, the control data 5 associated with this video data at may define the layout the layout of auxiliary data i.e. where the created auxiliary data is to appear relative to the video data and when this is to appear.

This may take the form of x-y axis coordinate data and defined time slots of the video data. For example:
at time x, insert text overlay {User Location} at grid location x=10, y=20 for a duration of 15 seconds; . . .

Typically the control data 5 associated with the video data at the primary data source defines placeholders for subsequent information which is to be retrieved from the secondary data sources 9 and/or from the primary data source 3. To this end the control data 5 may further indicate where the information for the placeholders may be obtained. As indicated by the statement above, for example {User Location}, the auxiliary data to be created can be tailored to be user specific. The primary data source 3 may be aware of secondary data sources 9 to which users may provide relevant personal information; typically such secondary data sources 9 may comprise one or more social media platforms including one or more of: Facebook; Google Plus; Twitter; Instagram; Snapchat or any other suitable social media platform or API. Therefore the control data 5 defines from which secondary data source 9 the user's location information may be obtained. This may be achieved by the provision of a general web address or the like with further information being provided by the user device 7, typically by the media player 11 thereon. Alternatively the control data 5 may be more specific as to where the information may be obtained based on information regarding the user of the user device already available to the primary data source 3, such as:
insert {User location} from https://facebook.com/usemumber12345/locationdata.html;

Following the association of the control data with the video data, the video data and control data 5 are then broadcast for receipt by the user device 7 having the media player 11 installed or otherwise accessible thereon. The media player 11 upon reading the control data 5 is configured to retrieve the user location information from one or more of the secondary data source(s) 9 and insert this at time x at grid location x=10, y=20 for a duration of 15 seconds as per the above. This for example may comprise where the {User location} indicates the user as being in London, showing a text advertisement for a product or service located in London.

In addition to this the control data 5 may also define what operation to perform if the data is not available or accessible at the designated location. For example where the control data 5 indicates that the auxiliary data element, e.g. user location, is to be retrieved from a first location at the secondary data source 9 and the media player 11 attempts to retrieve said user location data from the first location but there is an error and the information is not accessible at this location, the control data may indicate a second location from which the user location may be obtained, e.g. Instagram, or a stock location to provide where the information is not available from the second location or, instead the control data may simply indicate an alternative auxiliary data element to be inserted, e.g. graphic, instead of the user location. This example expresses a key advantage to the system of the present invention in that the primary data source 3 is not actually provided with the user location data, the primary data source is aware of a location from which this data may be obtained but the location data is not directly accessible by the primary data source 3 itself. The control data 5 acts as a pointer or placeholder to indicate what auxiliary data is to be provided, when it is to be provided and from where is it to be provided.

As mentioned above the auxiliary data created by the user device 7 may be tailored to the specific user thereof. The auxiliary data may contain user specific data such as: location; age; gender; interests or any other suitable user specific information. This user specific data may already be available to either the primary data source 3 and/or the secondary data sources 9 in which case the control data 5 may define the location upon the primary data source 3 and/or secondary data source 9 from which said user specific data may be retrieved as mentioned above. Further the control data 5 may already comprise some knowledge of user specific data such that the secondary data sources from which the media player 11 is configured to retrieve the one or more elements of the auxiliary data to be created by the media player 11 is determined based on this user specific data. For example, the secondary data sources relevant to a particular user may differ based upon the user's current location, age or any other user specific data Preferably personal information regarding the user is stored at the Secondary data sources 9 which the primary data source 3 does not have access to. However in order for the media player 11 to be able to obtain this user specific data the user may be required to provide consent regarding from which of the primary data source 3 and/or secondary data sources 9 information may be retrieved and what personal information may be retrieved therefrom, to this end user authentication may be required in order for this personal information to be retrievable from the primary 3 and/or secondary 9 data sources. Accordingly the user may be prompted to provide their consent for the media player 11 to retrieve one or more elements of auxiliary data from the primary data source 3 and/or the secondary data source(s) 9. Advantageously this provides the user with a greater level of control over which data, in particular their personal data, may be accessed for the generation of auxiliary data.

For example where the user specific data comprises location data, the control data 5 may indicate that this information can be retrieved from one of the secondary data sources 9 such as secondary data source alpha 17 or secondary data source beta 18 or secondary data source gamma 19. Upon accessing the media player 11, prior to playback of the video upon the user device 7, the user may be requested to provide their consent for the media player 11 to communicate and retrieve said personal data, in this case, location data from secondary data source alpha 17, wherein if the user consents, this location data may be retrieved from secondary data source alpha 17 and location dependent auxiliary data may be created by the media player for layering with respect to the video data directly on the user device 7. Wherein if the user indicates that they do not consent for their location information to be retrieved by the media player 11 then the control data may indicate a stock location or alternative auxiliary data to be created and presented.

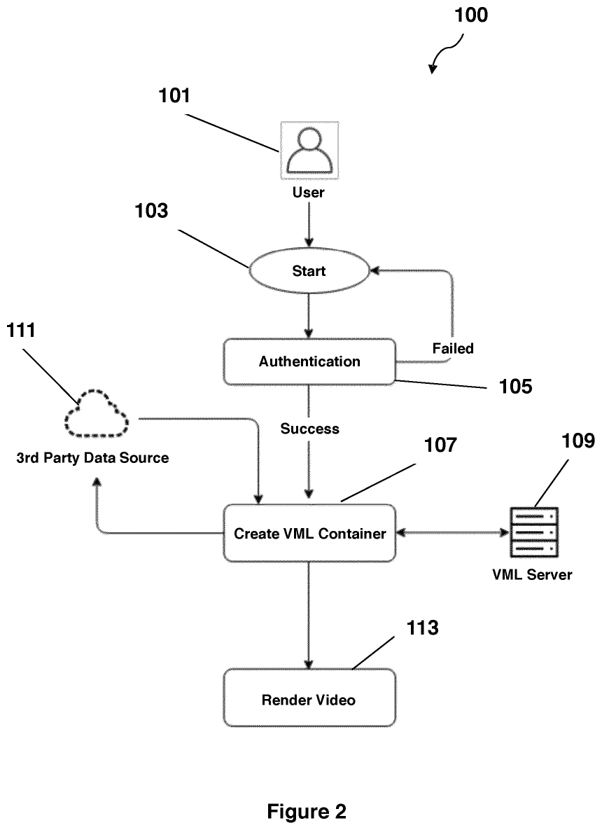

Referring now to FIG. 2 there is shown a flow diagram illustrating an authentication process 100 a user 101 may be prompted to undergo upon accessing the media player 11 to view the video data with associated control data 5 upon the user device 7. The user 101 upon accessing their user device 7 starts or otherwise initiates the media player upon their user device 103, upon initialisation or upon attempting to access a particular video, the user is prompted to provide their authentication 105. The user 101 is typically prompted to provide their consent for the media player 11 to retrieve PRI regarding the user from one or more of the secondary data sources 9 and/or the primary data source 3, this may be in the form of a single query or alternatively the user 101 may be presented with a list of secondary data sources 9 or different types of personal information e.g. age; sex; location; hobbies; brand preferences etc., which they may then individually select to allow for information to be retrieved from one or more of the secondary data sources 9 and one or more types of personal information. If the user 101 fails to provide their consent for the media player 11 to access any secondary data sources 9 and/or any type of personal information, then the media player 11 may indicate a fail and consequently not playback the video requested by the user 101. Subsequently the user 101 may be re-prompted to provide their consent for the media player 11 to retrieve information from the secondary data sources 9. Additionally or alternatively where the user 101 is presented with a selection of secondary data sources 9 and/or different types of personal information and fails to provide their consent for the media player 11 to retrieve said information, when re-prompted for their consent the user 101 may be provided with a different selection of secondary data sources 9 and/or different types of personal information for them to provide their consent to be retrieved.

Wherein if the user 101 consents for the media player 11 to retrieve PRI regarding the user from one or more of the secondary data sources 9 and/or the primary data source 3, the media player 11 is configured to read the control data 107 and retrieve the elements of the auxiliary data to be created from the primary data source 109 and secondary data sources 111. Following receipt of these the video playback is started on the user device 7 and the auxiliary data is created locally on the user device 7 in-real time 113. It should be understood from the foregoing that where mentioned that, the elements of the auxiliary data to be created are “retrieved” or “fetched” from primary data source 109 and secondary data sources 111, that this auxiliary data is typically in the form of metadata which the media player 11 uses to render and create the auxiliary data locally on the user device 7.

Further the control data 5 typically indicates what happens to the generated auxiliary data when the playback of the video ends, in particular the control data 5 typically indicates that the generated auxiliary data and/or raw video data stops being rendered or created on the media player 11 of the user device 7 such that it is no longer viewable on the user device 7 once the video has finished. This advantageously serves to provide further privacy to the user as the generated auxiliary data will not be viewable to subsequent users of the user device 7 and the auxiliary data created based on the users personal information is not stored on the user device 7. It is also highly advantageous from a data storage perspective, as the memory locally on user devices 7 can be quite limited and is therefore carefully conserved, as the auxiliary data is created locally only during the playback of the video data and stops being rendered once the video data playback has stopped, the memory utilised for the creation of the auxiliary data is kept to a minimum, typically only temporary memory of the user device 7 such as the cache memory for example, thus freeing the local data storage up for other tasks.

Advantageously, the disclosed arrangement, in particular the independence of data exchange between the primary data source 3 and secondary data sources 9, ensures that data compliance laws are upheld whilst providing for the creation of large amounts of personalised video containing Personally identifiable information (P11) and 3rd party data. Large amount of videos can be created without rendering each of them separately in the server, this avoids processing or storing P11 from user authenticated secondary data sources 9. The control data 11 tells the media player 11 how and from where to retrieve data from the primary data source 3 and/or secondary data sources 9 and render them with the video in real-time locally on the user devices 7. The control data 5 further typically comprises instructional files containing one or more algorithms or other suitable instruction means which are configured to retrieve or fetch data from the primary data source 3 and/or secondary data sources 9 and tells the media player 11 to add the fetched data seamlessly into the video. The control data 5 can only be read by the media player 11 and cannot be used outside of the media player 11. Once the user authenticates their access to secondary data sources 9, typically comprising third party API services such as but not limited to Facebook, LinkedIn, etc., in their device 7, data pulled from the secondary data sources 9 is never sent to the primary data source 3. The media player 11 is initiated when the user starts watching the video. Data received from different sources, primary data source 3 and/or secondary data sources 9, are dynamically rendered as a single video. Dynamic data rendering happens in the user device 7 within the media player 11, no P11 or data from third party sources are shared outside the media player 11. Further the contents inside the media player 11 only exist when the user is watching a video. The media player 11 and its contents will be destroyed after the user finish watching the video on their device and closes the player.

It should be understood that the auxiliary data created relating to the personal data of the user may not simply be a visual representation of said personal data but may go further to utilise this data as a building block for more relevant and targeted auxiliary data. Take for example where the personal data comprises location data, the auxiliary data created based on this location data may take a number of different forms. To start with where the user data indicates their location as being in France, text overlays may all be presented in the French language and/or further where the location data also indicates their location as being in Strasbourg, France the auxiliary data may then comprise graphics and/or text comprising advertisements regarding services and products available in their local area i.e. Strasbourg. Additionally where the location data indicates that the user is located in France, the auxiliary data may comprise a live feed of information such as but not limited to weather, news, sport, stock market information etc. This live fee of information may be in the form of a ticker or other suitable means of presentation which is overlaid on top of or below the raw video data.

Advantageously this shows the versatility of the disclosed invention in that not only are data privacy concerns being addressed but from a commercial perspective the system and method are operable to provide targeted and relevant information to the users which is turn highly advantageous to the primary data source 3 and the secondary data sources 9 and the companies which they represent in real world application.

As the control data 5 typically comprises metadata no actual auxiliary data is broadcast from either the primary data source 3 or the secondary data sources 9, the metadata defines the auxiliary data which is to be created locally on the user devices 7 by the media player 11. This is particularly advantageous from a data storage and bandwidth perspective as typically where auxiliary data is to be added to videos this would involve rendering separate video files with the auxiliary data into a single file which are then broadcast to the user device, as the auxiliary data may contain a significant amount of graphics, videos and other forms of auxiliary data these personalised video files would be of fairly significant size for broadcasting to a user device, consume significant amounts of bandwidth as a result. In comparison in the present invention the raw video data is broadcast with the associated control data 5 comprising metadata which is of a much reduced file size in comparison thus making it much more bandwidth efficient. Further it is also much more advantageous from a data storage perspective as the auxiliary data is represented only by virtue of the metadata but this acts as a pointer for its creation locally on the user devices 7, therefore no auxiliary data is required to be stored at the primary data source 3 and/or the secondary data sources 9. As mentioned traditional methods of producing personalised digital video involves large amounts of computing power, where each personalised adaption of each video for each user must be generated and stored. Required data for the personalised elements of the video must be taken, processed and used to generate the video before the user watches it. The more users to be provided with a personalised video, the greater the cost, required time and energy usage of generating and storing all of the video adaptions. The present invention is much more advantageous in this regard as all of the processing is done locally on the users device 7 when the video is desired to be watched only, as opposed to the pre-distribution and storage approach commonly implemented, this advantage is illustrated in FIG. 1B of the drawings which is generally indicated by the reference numeral 10B which shows a graph illustrating how as the number users requiring personalised videos increases the time, cost and energy usage remains substantially fixed.

Traditionally, computer programs are used to generate personalised video using data related to the target user. This generation is normally done on one or more servers which are costly to set up, run and maintain and the more videos that need to be generated, the greater the financial burden as result of data storage on the servers. For a large number of users, if the time period to generate a video for each user is limited, more servers may be required to split up the generation work and run the tasks in parallel, so that the total workload can done within this frame of time. This in turn requires introduces further cost, time and energy consumption. The time and energy usage required for the generation of the video correlates positively with the file-size of the master video file(s), the quantity of data to process for personalisation, effects that need to be applied to the video and the processing power of the computing environment. Each rendered video must be stored on data storage that is accessible through a server so that the user and download or stream the personalised video, so the cost and energy usage continues to increase even after the video has been generated. Storage and distribution of a large quantity of videos will require the use of data centres which are expensive to run and procure use of, and also require large amounts of energy.

In normal circumstances, a server is always running and consuming electricity. For the traditional method of producing personalised video, this can result in the consumption of a large amount of energy. Because the videos that are produced are done so in advance of the user being able to watch them, the video may not be watched at all, resulting in the wastage of electricity and financial resources. In a time where energy conservation is more important than ever before and where companies are under constant scrutiny for their environmental practices, this traditional method may prove problematic. The proposed method and system of the present invention address these deficiencies of the current practice as it allows for personalised video to be generated in real-time for the user locally on the user's device 7. This means that the video is only generated if the user attempts to watch it. The video isn't physically stored anywhere on the user device 7 and all processing and rendering is performed on the user's device 7, which saves financial resources, energy and does not require any rendering or processing in advance.

Advantageously the method and system described herein provide means by which a video can be constructed on the user device 7 that can take unconnected data from multiple sources and render them into one seamless video. The video can be personalised to any user viewing the video based on any preference about them such as the time it is viewed and the location it is viewed and any data from any service that may contain their data. With this invention, the data and video are interconnected, are rendered in real-time on the user's device of consumption. This enables the creation of an infinite amount of personalised video with the possibility of real-time information being embedded within the video. Video consumers have full control and knowledge of what first and third party data is used while knowing that no data is shared across any of the connected services. Further the invention enables the creation of an infinite amount of personalised videos without creating and storing a rendered video for each iteration.

The media player 11 aggregates all of the collected information from the primary data source 3 and secondary data sources 9, combines that with the control data 5 initially broadcast from the primary data source 3 which provides the template for the auxiliary data to be created relative to the raw video data and renders this into a ‘personalised’ video for the user. This process works work by pulling in and rendering real-time data, at the point in which it should be consumed and as the data changes the video updates in real-time as the user is watching the video while ensuring the data can/is personal to the user, as defined by the control data 5.

All of the data retrieval and processing happens on the client-side consumption device. No data is ever shared between the primary data source 3 and secondary data sources 9. This allows for data compliance, as no extra data is ever stored or created with the aggregated data. With this invention, the first party service i.e. the primary data source 3 can deliver a personalised service based on what data is available to the user at the point of consumption, this is known by the control data 5. The control data 5 as stated previously knows at what point the data in the video should be retrieved, but also provides means which enables the media player 11 to adapt if it can't access a retrieval location for desired data, i.e. a “negative input” scenario. This adjustment within the video can happen instantly. The adjustments, are but not limited to video adjustment, audio adjustment, data adjustment, point of location consumption. This is facilitated by the feature of the control data 5 performing as a placeholder. At any point where there is data being requested, is being interlaced into the video by the control data 5 which defines all elements of the auxiliary data to be retrieved, created.

With this method, no excess data is ever created as the media player 11 is retrieving the data from the primary data source 3 and secondary data sources 9 based on the control data 5 and rendering auxiliary data whilst the video is played locally on the user device 7. This process allows the primary data source 3 to deliver a personalised and/or real-time video experience without needing to process or store any information from the secondary data sources 9 or store them within the video itself. Personalised data that is displayed within a video at the time of consumption only exists while the user is “viewing” the video on their device 7 of consumption. Within the user-side media player 11, the data is connected in real-time within the media player 11. No data leaves the client's device of consumption 7 so therefore no external data or PII exists outside of the user's device 7. The data processing occurs on the client-side upon the users devices 7, not on any servers, in particular not at the primary data source 3 or secondary data sources 9. As the video and generated auxiliary data are from unconnected sources, this enables the ability to deliver video containing personally identifiable information, while ensuring that no 3rd party service i.e. the secondary data sources 9 are able to see or process any data from a service that is not their own.

Due to the real-time nature of this invention, this enables us to both retrieve and annul content. This means from the control data 5 we are able to state what happens when we ‘complete’ a stream, and what is defined as complete i.e. typically the end of the video playback. As mentioned previously this also means that we are able to annul all generated auxiliary data after a video has completed. For example this may comprise where the video has been watched once, once the end of the video is reached the auxiliary data and/or video data is deleted from the user device 7, or alternatively where the media player 11 is incorporated within a webpage or the like, whenever the established session between the user and media player 11 is ended e.g. where the webpage is closed. This advantageously adds an additional layer of security and control over the data that the secondary data sources 9 are able to access.

It will be understood that what has been described herein is an exemplary system for distributing video content. While the present teaching has been described with reference to exemplary arrangements it will be understood that it is not intended to limit the teaching to such arrangements as modifications can be made without departing from the spirit and scope of the present teaching.

It will be understood that while exemplary features of a distributed network system in accordance with the present teaching have been described that such an arrangement is not to be construed as limiting the invention to such features. The method of the present teaching may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside. Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components. The processor(s) may be programmed to perform the functions of the first, second, third and fourth modules as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S.

Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, Json and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch process the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

The invention is not limited to the embodiment(s) described herein but can be amended or modified without departing from the scope of the present invention.

1.-23. (canceled)

24. A method for distributing video content across a network, the method comprising:
providing video data to a primary data source;
associating control data with the video data;
broadcasting the video data with associated control data from the primary data source to one or more user devices across the network;
providing a media player on the respective user devices which is operable in response to reading the control data to create auxiliary data locally on the respective user devices while the media player is playing the video data; and
creating the auxiliary data locally on the respective user devices while the media player is playing the video data locally on the respective user devices;
wherein the control data defines one or more elements of the auxiliary data to be created by the media player including the elements of the auxiliary data which are to be retrieved from the primary data source and one or more secondary data sources.

25. The method of claim 24, wherein the control data comprises metadata.

26. The method of claim 25, wherein the control data comprises a data interchange format/or data storage format.

27. The method of claim 24, wherein the control data contains instructions defining the elements of the auxiliary data, the elements of the auxiliary data comprising one or more of:
a layout of the auxiliary data relative to the video data;
one or more types of auxiliary data to be provided relative to the video data;
at least a first location from which the auxiliary data is to be retrieved from the primary data source and/or secondary data sources;
a time at which the auxiliary data is to be provided relative to the video data; and/or an action to be performed to the auxiliary data when the video playback is ended.

28. The method of claim 27, wherein the action to be performed to the auxiliary data when the video playback is ended comprises ceasing the creation of the auxiliary data locally on the media player.

29. The method of claim 27, wherein the control data further defines a second location from which the auxiliary data is to be retrieved from the primary data source and/or secondary data sources if the auxiliary data is not available at said first location.

30. The method of claim 27, wherein the one or more types of auxiliary data are provided at different times during playback of the video data.

31. The method of claim 24, wherein the one or more types of auxiliary data comprise one or more of: customisable text overlays; graphics; sounds; secondary video data; special effects; and/or live feeds or displays of information.

32. The method of claim 24, wherein the auxiliary data comprises user specific data, wherein the user specific data comprises data regarding a user of the user device.

33. The method of claim 32, wherein the user specific data comprises one or more of:
user location; user age; user gender; user interests or hobbies; user language; user search history;
user web history and/or any other suitable user specific information.

34. The method of claim 32, wherein the user specific data is stored upon one or more of the secondary data sources and/or primary data source and/or user device and/or media player.

35. The method of claim 32, wherein the secondary data sources from which the media player is configured to retrieve the one or more elements of the auxiliary data to be created by the media player is determined based on one or more elements of the user specific data.

36. The method of claim 24, wherein prior to creating the auxiliary data locally on the respective user devices while the media player is playing the video data locally on the respective user devices, the method further comprises:
authenticating the media player with the secondary data sources to allow for the media player to retrieve the auxiliary data from the secondary data sources.

37. The method of claim 36, wherein authenticating the media player with the secondary data sources comprises requesting the user to provide their consent for the media player to retrieve one or more elements of the auxiliary data from one or more of the secondary data sources.

38. The method of claim 36, wherein authenticating the media player with the secondary data sources comprises verifying that the user has previously provided their consent for the media player to retrieve one or more elements of the auxiliary data from one or more of the secondary data sources.

39. The method of claim 37, wherein the control data contains instruction defining what action is to be performed if the user's consent is not obtained or verified.

40. The method of claim 39, wherein the control data indicates that the video playback on the user device is not to occur on the media player or that pre-defined auxiliary data is to be created during playback of the video on the media player.

41. The method of claim 40, wherein the type of pre-defined auxiliary data to be created is defined in the control data.

42. The method of claim 40, wherein the pre-defined auxiliary data is retrieved from the primary data source.

43. The method of claim 24, wherein the primary data source and/or secondary data sources comprise a cloud and/or local server architecture and/or an API service and/or any data storage format file and/or JSON file and/or a computing device and/or any data storage format or other suitable data source.

44. The method of claim 24, wherein the media player is configured to create and synchronise the auxiliary data in real time with the video data whilst the video data is played on the user device.

45. The method of claim 24, wherein the user devices comprise a smartphone, tablet, laptop or any other suitable computing device

46. A system for distributing video content across a network, the system comprising:
a primary data source;
one or more user devices; and
one or more secondary data sources;
wherein the primary data source is configured to associate control data to video data provided to the primary data source;
wherein the primary data source is configured to broadcast the video data and associated control data for receipt by the one or more user devices;
wherein the user devices contain a media player provided thereon which is configured to create auxiliary data locally upon the respective user device in response to reading the control data when the video is played on the user device; and
wherein the control data defines one or more elements of the auxiliary data created by the media player locally on the user devices including elements of the auxiliary data which are to be retrieved from the primary data source and the one or more secondary data sources.
